(19) United States
(12) Patent Application Publication
(10) Pub. No.: US 2026/0045144 A1
(43) Pub. Date: Feb. 12, 2026

(54) RANDOM NUMBER GENERATOR CONVERSION ENGINE FRAMEWORK

(71) Applicant: Aristocrat Technologies, Inc., Las Vegas, NV (US)

(72) Inventor: Joseph Ward, III, Reno, NV (US)

(21) Appl. No.: 18/799,188

(22) Filed: Aug. 9, 2024

(51) Int. Cl. G07F 17/32

(52) U.S. Cl. CPC G07F 17/326

(57) ABSTRACT

The disclosed systems and methods may include (1) selecting a certain ultimate outcome from an ultimate outcome table with a variety of ultimate outcomes (e.g., where each ultimate outcome within the ultimate outcome table corresponds to a different initial outcome table, each initial outcome table includes one or more symbol combinations, and each symbol combination within an initial outcome table includes a combination of symbols that yields the initial outcome table's corresponding ultimate outcome), (2) in response to selecting the certain ultimate outcome from the ultimate outcome table, selecting, from a certain initial outcome table corresponding to the certain ultimate outcome, a certain combination of symbols that yields the ultimate outcome, and (3) presenting, via a display element of a device, the certain combination of symbols selected from the certain initial outcome table. Various other methods, systems, and computer-readable media are also disclosed.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player.

Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

In some examples, the disclosed framework for generating game outcomes using a random number generator (RNG) conversion engine may include multiple tables: (1) an ultimate outcome table and (2) a set of initial outcome tables. In some examples, one or more of the tables may be weighted. The ultimate outcome table may include multiple ultimate outcomes (e.g., one or more prize-outcomes such as a payout, a no-prize outcome, a bonus outcome such as an option to spin a digital wheel, etc.). Each ultimate outcome in the ultimate outcome table may be logically associated with a different initial outcome table. In some examples, an initial outcome table may correspond to a single ultimate outcome and may include multiple symbol combinations, each of which yields this same ultimate outcome.

In the disclosed framework, an RNG conversion engine of a device may be configured to select a combination of symbols to present to a player (e.g., in a row-by-column grid or matrix of a slot type game) by first randomly selecting an ultimate outcome from the ultimate outcome table. In response to randomly selecting the ultimate outcome, the RNG conversion engine may access an initial outcome table corresponding to the selected ultimate outcome (i.e., a table that includes multiple symbol combinations, each of which yields the selected ultimate outcome). Then, the outcome module may randomly select a symbol combination from the selected initial outcome table and present the selected symbol combination to the player (e.g., along with awarding a prize in instances in which the selected ultimate outcome includes a prize).

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates, in block diagram form, a multi-table framework for selecting player symbol combinations.

FIG. 5 illustrates a flow chart for selecting player symbol combinations using the multi-table framework of FIG. 4.

FIG. 6 illustrates an exemplary display with a selected symbol combination.

FIG. 7 depicts an exemplary display with a winning outcome.

FIG. 8 depicts an exemplary display with a losing outcome.

FIG. 9 depicts an exemplary display with a bonus outcome.

FIG. 10 depicts an exemplary digital wheel.

### DETAILED DESCRIPTION

This application discloses various frameworks for generating outcomes of games for gaming devices. In a traditional outcome-generation framework for a game, a single table includes a list of various combinations of symbols that may be presented to a user playing the game (e.g., in a row-by-column grid or matrix of a slot type game). The various combinations of symbols may be weighted based on the ultimate outcomes (e.g., a prize, no-prize, and/or a bonus outcome) yielded by each of the various symbol combinations (e.g., to achieve a designated return to player (RTP)). Because the number of possible symbol combinations may be large, the number of entries in this traditional single table may be correspondingly large. As such, accessing and processing such a table may require high CPU and memory usage. Additionally, because symbol combinations are selected from the single table at random, unanticipated outcomes (e.g., winning streaks or losing streaks) may occur. In contrast, the disclosed two-table framework selects a combination of symbols to present to a player in two steps. First, an ultimate outcome is selected for the player at random from an ultimate outcome table (e.g., a table that is weighted based on a designated RTP). Second, an initial outcome table corresponding to the selected ultimate outcome is accessed. The initial outcome table includes (e.g., consists of) different combinations of symbols (e.g., each combination of symbols) that yield the selected ultimate outcome. A combination of symbols is selected (at random) from the initial outcome table and the selected combination of symbols is presented to the user.

Because the number of possible ultimate outcomes is substantially smaller than the number of possible symbol combinations, selecting first from an ultimate outcome table (and then selecting from an initial outcome table that only includes symbol combinations corresponding to a selected ultimate outcome) substantially reduces the computational burden on the CPU and substantially decreases the memory usage required to make a symbol combination selection (relative to the CPU and memory usage required using traditional single table frameworks). Using a two-table approach to select a symbol combination also improves the accuracy of the RTP of the game as the RTP depends on the selected ultimate outcomes, not symbol combinations. Thus, by selecting a symbol combination based on a selected ultimate outcome, RTP may be regulated more directly and accurately.

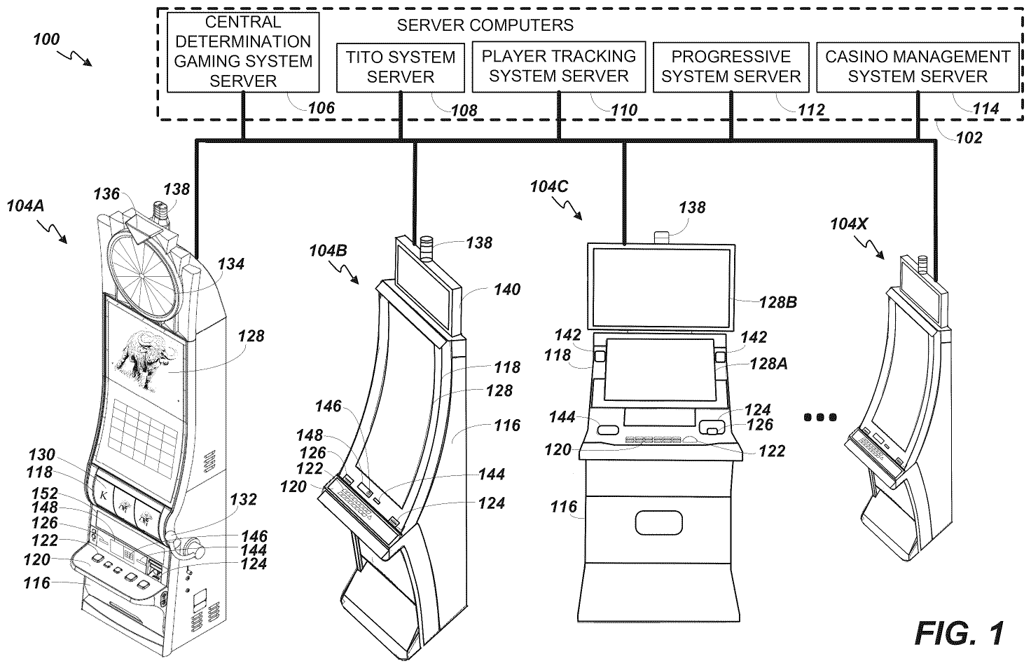

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet.

Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

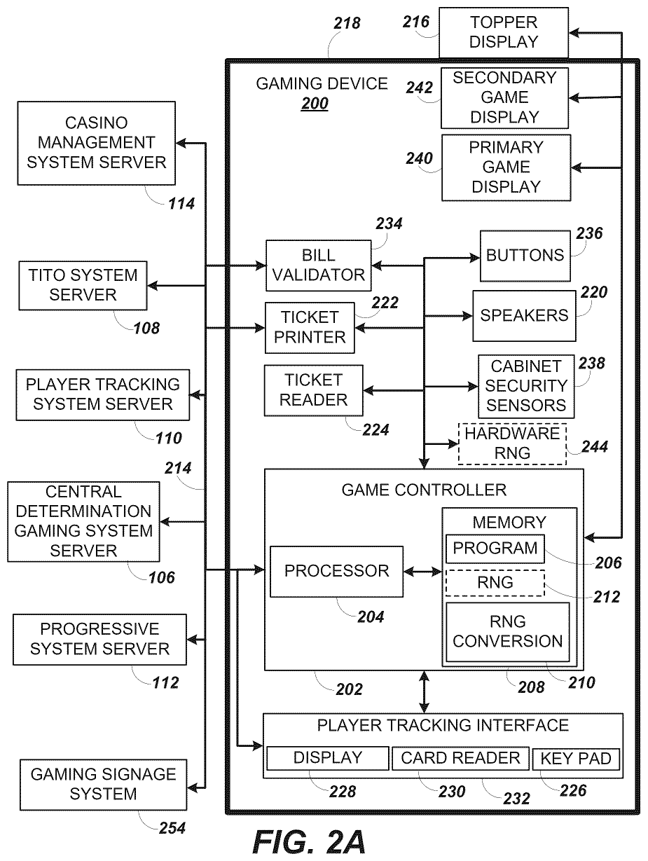

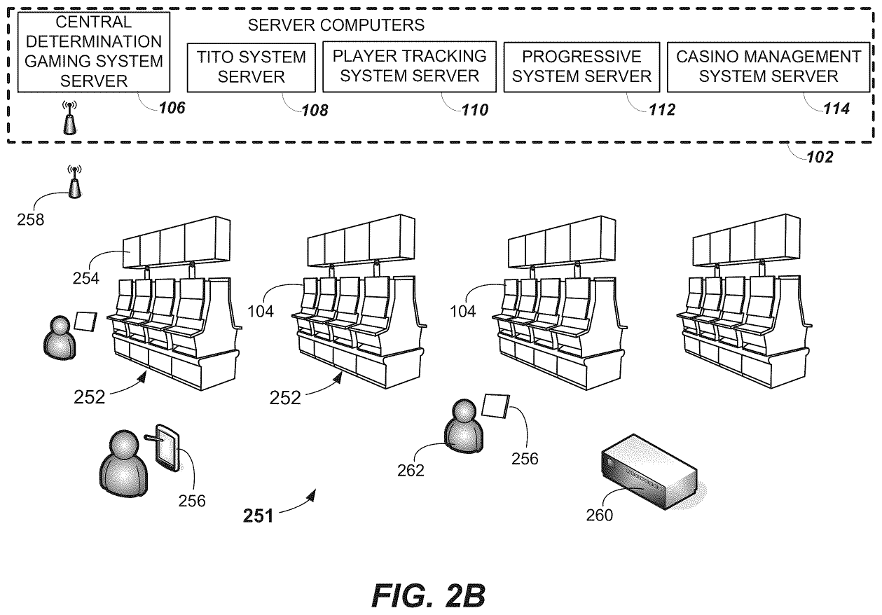

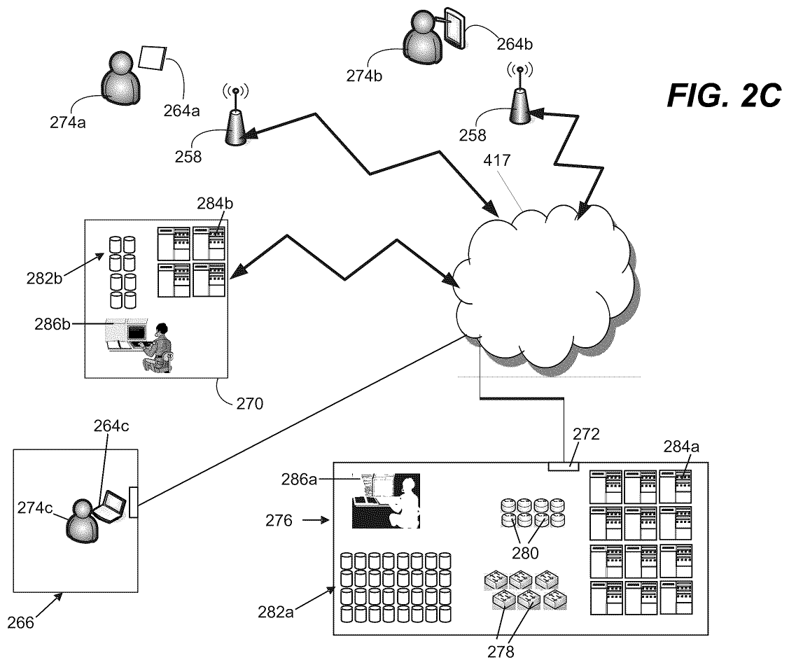

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers.

Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices.

Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power.

Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200.

When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances.

The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A).

According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication.

Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

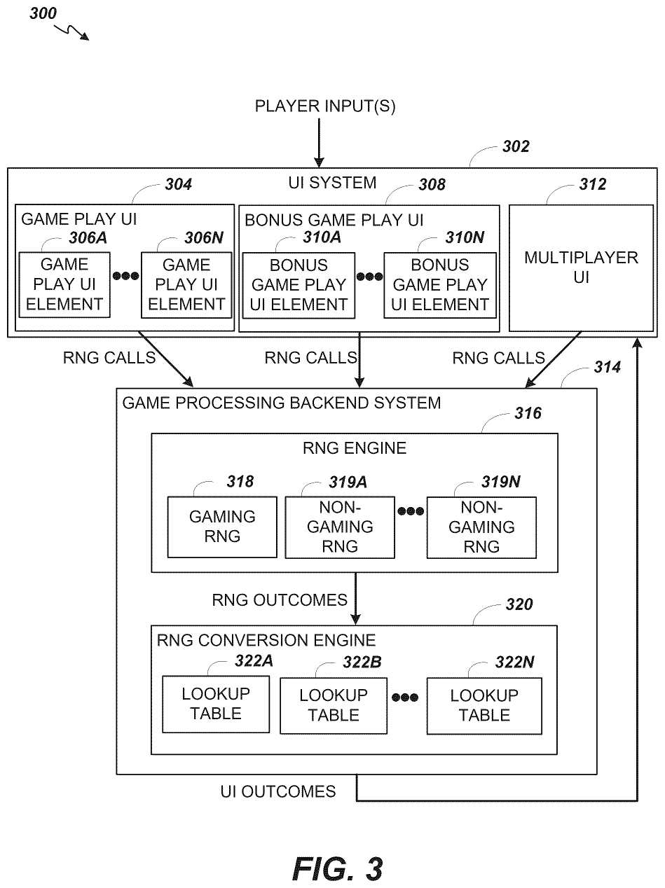

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1. In some examples, game processing architecture 300 can implement the game processing pipeline using a user device via a mobile gaming application installed on the user device and/or accessed via a browser of the user device. In these examples, the user device may generally represent any type or form of computing device capable of reading computer-executable instructions.

The UI system 302 includes one or more UIs that a player can interact with. The UI system 302 could include one or more game play UIs 304, one or more bonus game play UIs 308, and/or one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N.

Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

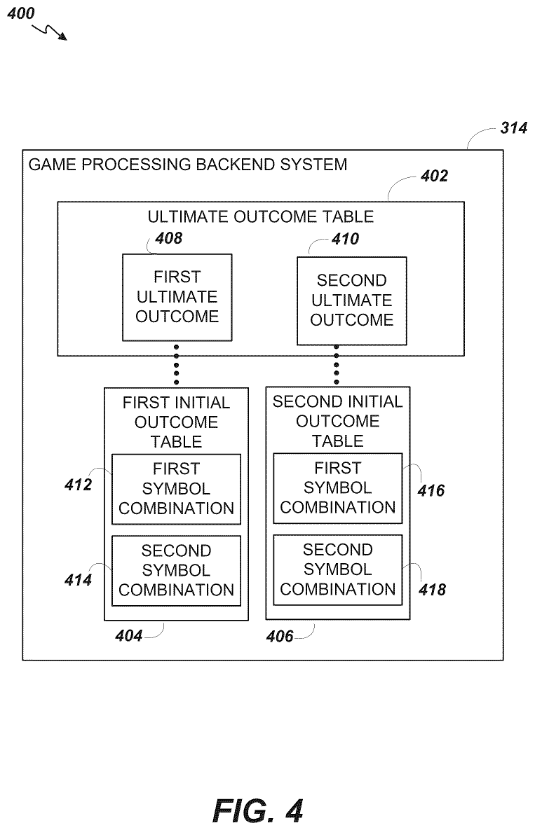

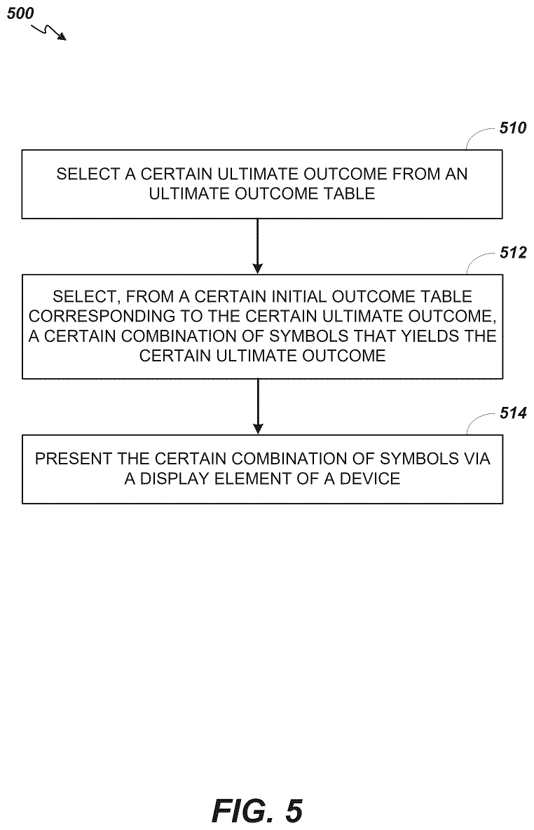

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In some examples, lookup tables 322A-322N could include an ultimate outcome table and two or more initial outcome tables, as will be described in connection with FIGS. 4-5. Additionally or alternatively, the RNG conversion engine 320 could utilize one lookup table (e.g., one set of lookup tables) to map the RNG outcome to a game outcome displayed to a player and a subsequent lookup table as a pay table for determining the prize payout amount for each game outcome. In one such example, the mapping between the RNG outcome and the game outcome can control the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

FIG. 4 illustrates, in block diagram form, an implementation of a game outcome selection framework 400. In some examples, framework 400 may be executed by game processing backend system 314 as part of game processing architecture 300 as described in connection with FIG. 3. FIG. 4 depicts two types of tables used (e.g., by RNG conversion engine 320) to generate a game outcome to display to a player: an ultimate outcome table (e.g., table 402) and an initial outcome table (e.g., first initial outcome table 404 and second initial outcome table 406). The term “initial outcome” may refer to a set of symbols presented to a player playing a game (e.g., in response to the player initiating the game). The set symbols may include any type or form of symbol (e.g., fruits, bars, numbers, shapes, etc.). The term “ultimate outcome” may refer to a gaming outcome indicated by a set of symbols. Examples of ultimate outcomes may include winning a prize (e.g., a payout), a no-prize outcome, and/or a bonus outcome (e.g., an option to spin a digital wheel, an option for an extra play, etc.).

As shown in FIG. 4, ultimate outcome table 402 includes entries for multiple outcomes (e.g., first ultimate outcome 408 and second ultimate outcome 410). While FIG. 4 depicts two outcomes, it should be appreciated that ultimate outcome table 402 may include any number of outcomes. In some examples, ultimate outcome table 402 may include (1) one or more prize outcomes (e.g., with a single prize outcome entry or a different prize outcome entry for each potential prize amount that may be awarded to a player), (2) a no-prize outcome, and/or (3) one or more bonus outcomes (e.g., an option to spin a digital wheel). In some examples, the outcomes within ultimate outcome table 402 may be weighted (e.g., according to a designated RTP).

As shown in FIG. 4, each ultimate outcome included within ultimate outcome table 402 may be associated with its own dedicated initial outcome table. For example, first ultimate outcome 408 may be associated with first initial outcome table 404 and second ultimate outcome 410 may be associated with second initial outcome table 406. Each ultimate outcome, when selected, may trigger its dedicated initial outcome table to be accessed (as will be discussed in greater detail below in connection with FIG. 5). Each initial outcome table may include one or more symbol combinations, each of which yields the ultimate outcome corresponding to the initial outcome table. For example, first initial outcome table 404 may include first symbol combination 412 and second symbol combination 414, each of which is configured to yield first ultimate outcome 408. Second initial outcome table 406 may include first symbol combination 416 and second symbol combination 418, each of which is configured to yield second ultimate outcome 410. While FIG. 4 depicts two symbol combinations in each initial outcome table, it should be appreciated that an initial outcome table may include any number of symbol combinations. In some examples, one or more of the symbol combinations within an initial outcome table may be weighted.

FIG. 5 is a flow diagram of an exemplary computer-implemented method for selecting a gaming outcome. The steps shown in FIG. 5 may be performed by any suitable computer-executable code and/or computing system, including the systems illustrated in FIGS. 1-4. In some examples, the steps shown in FIG. 5 may be performed by modules operating in an endpoint device such as a gaming device (e.g., operating in a casino environment as described in connection with FIG. 1) and/or a personal user device (e.g., a smart phone, tablet, laptop, wearable device, and/or desktop), and/or by modules operating in a server (e.g., a backend computing device). In one example, each of the steps may represent an algorithm whose structure includes and/or is represented by multiple sub-steps, examples of which will be provided in greater detail below.

At step 510, one or more of the systems may select a certain ultimate outcome from an ultimate outcome table that includes multiple ultimate outcomes. For example, an outcome module (e.g., RNG conversion engine 320 and/or a module operating as part of and/or in connection with RNG conversion engine 320) may select first ultimate outcome 408 from ultimate outcome table 402. The systems may select first ultimate outcome 408 in a variety of ways. In some examples, first ultimate outcome 408 may be selected from the outcomes of ultimate outcome table 402 at random (e.g., using an RNG engine as described at FIG. 3). The systems may select an ultimate outcome from ultimate outcome table 402 in response to a variety of triggers. For example, the systems may select an ultimate outcome in response to receiving user input from a player initiating a game (e.g., as described in connection with FIG. 3).

In response to selecting the certain ultimate outcome (e.g., at random) from the ultimate outcome table, one or more of the systems may, at step 512, select from a certain initial outcome table corresponding to the certain ultimate outcome, a certain combination of symbols that yields the certain ultimate outcome. For example, an outcome module (e.g., RNG conversion engine 320 and/or a module operating as part of and/or in connection with RNG conversion engine 320) may, in response to selecting first ultimate outcome 408 from ultimate outcome table 402, (1) access first initial outcome table 404 (e.g., a dedicated initial outcome table corresponding to first ultimate outcome 408) and (2) select (e.g., at random using an RNG engine as described at FIG. 3) first symbol combination 412 from first initial outcome table 404. In some examples, there may be a 1:1 ratio between the ultimate outcomes in ultimate outcome table 402 and the initial outcome tables, where each ultimate outcome corresponds to one dedicated initial outcome table. As described previously in connection with FIG. 4, first symbol combination 412 may (as with all of the symbol combinations within first initial outcome table 404) be configured to yield first ultimate outcome 408.

In response to selecting the certain combination of symbols, one or more of the systems may, at step 514, present, via a display element of a device, the certain combination of symbols selected from the certain initial outcome table. For example, an outcome module (e.g., RNG conversion engine 320 and/or a module operating as part of and/or in connection with RNG conversion engine 320) may present, via a UI system such as UI system 302 depicted in FIG. 3, first symbol combination 412. Upon presenting first symbol combination 412 (or as part of presenting first symbol combination 412), the systems may present an indication of first ultimate outcome 408 within the display element and/or award a prize (e.g., a payout) and/or a bonus yielded by first ultimate outcome 408.

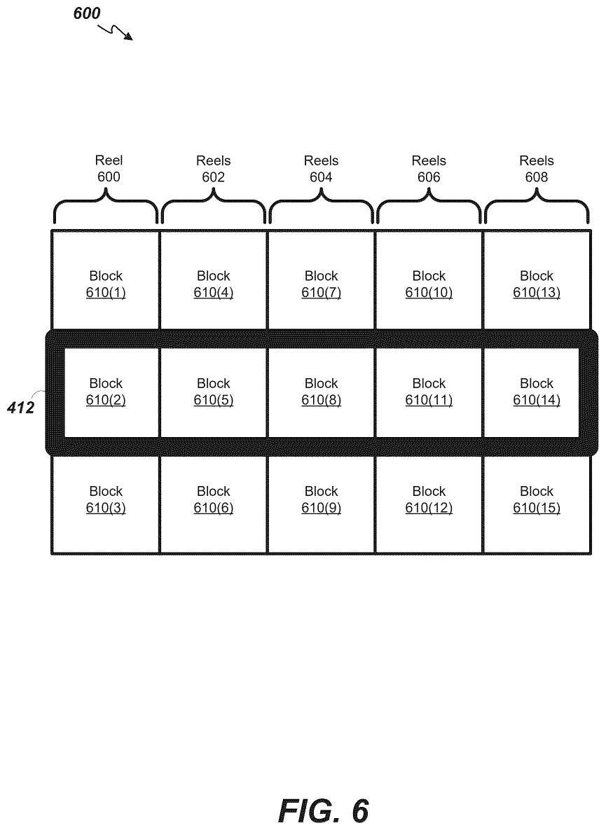

The systems may present the certain combination of symbols in a variety of ways. In some examples, the display element may include a series of reels and the combination of symbols may include a different symbol for a payline that spans each reel. For example, FIG. 6 depicts an exemplary display 600 with five reels (reel 600, 602, 604, 606, and 608). Each reel includes three blocks (blocks 610(1)-610(15)). In exemplary display 600, the payline is the middle block of each reel (i.e., blocks 610(2), 610(5), 610(8), 610(11), and 610(14)). In this example, the certain combination of symbols (e.g., first symbol combination 412) may represent a combination of five symbols (e.g., arranged in a particular order) and the systems may present the certain combination of symbols by presenting the first symbol of the combination in block 610(2), the second symbol of the combination in block 610(5), the third symbol of the combination in block 610(8), the fourth symbol of the combination in block 610(11), and the fifth symbol of the combination in block 610(14).

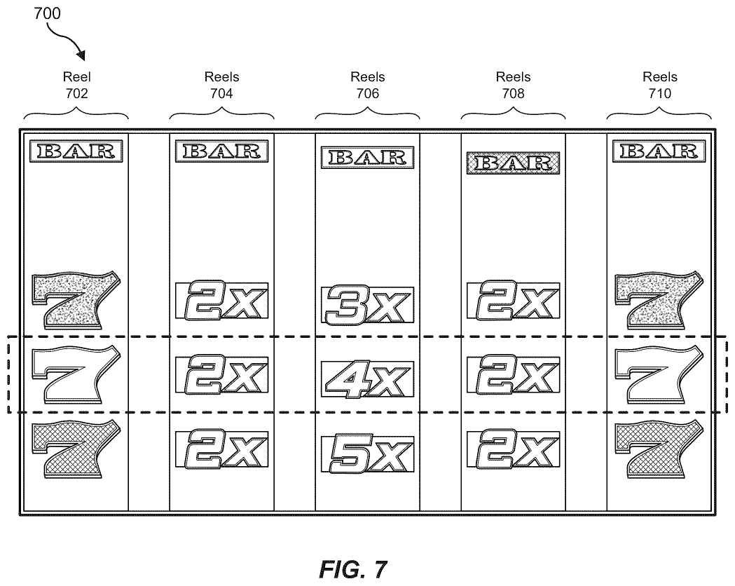

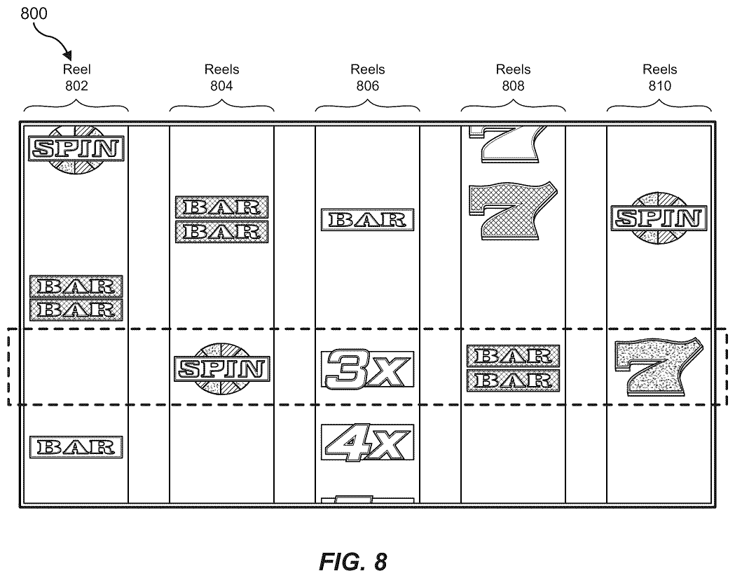

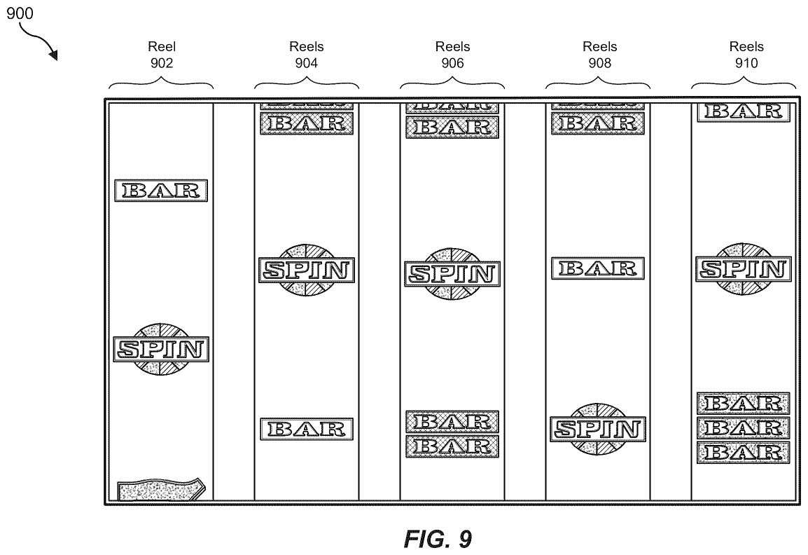

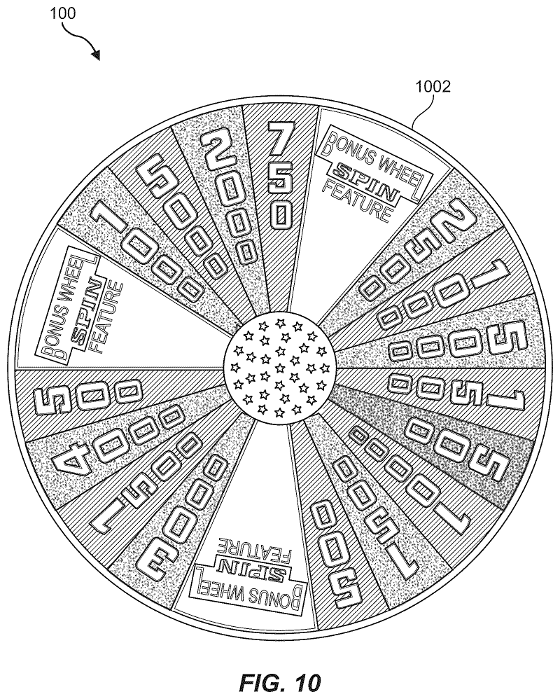

FIG. 7 depicts an exemplary display 700 with a winning outcome. In display 700 there are five reels (702, 704, 706, 708, and 710) and the payline includes five symbols: 7 (selected for reel 702), 2× (selected for reel 704), 4× (selected for reel 706), a second instance of 2× (selected for reel 708), and a second instance of 7 (selected for reel 710). In this exemplary display, this combination of symbols represents a winning combination (e.g., a combination that yields a payout of a designated amount). FIG. 8 depicts an exemplary display 800 with a losing outcome. In display 800, there are five reels (802, 804, 806, 808, and 810) and the payline includes five symbols: a blank selection (selected for reel 802), a spin selection (selected for reel 804), 3× (selected for reel 806), a double bar selection (selected for reel 808), and 7 (selected for reel 810). In this exemplary display, this combination of symbols represents a losing combination (e.g., in which no payout or bonus is provided to the user). FIG. 9 depicts an exemplary display 900 with a bonus outcome (the option to spin a wheel). In display 900, there are five reels (902, 904, 906, 908, and 910). In this example, the payline is nonlinear and includes a spin selection in all five reels (a combination configured to yield the option to spin a wheel). In examples in which a bonus includes a wheel spin, the wheel spin can yield a variety of outcomes (e.g., a winning outcome, a losing outcome, etc.). FIG. 10 depicts an exemplary display 1000 with a digital wheel 1002 with various outcomes. In some examples in which a bonus outcome includes a bonus play, an RTP may be different for the bonus play than a regular play (e.g., the RTP may be higher for the user than the RTP in a regular play).

In one embodiment, the steps of FIG. 5 may correspond to a game of bingo and the combination of symbols may correspond to symbols on a bingo card (e.g., an electronic bingo card). In this embodiment, the player may have been provided with the bingo card, which may include randomly generated symbols. An outcome module (e.g., RNG conversion engine 320 and/or a module operating as part of and/or in connection with RNG conversion engine 320) may (1) determine an ultimate outcome for the player (e.g., winning a prize such as a payout, no-prize, or winning a bonus) by randomly selecting an outcome from ultimate outcome table 402, (2) access an initial outcome table corresponding to the outcome selected from ultimate outcome table 402, (3) select (e.g., at random) a combination of symbols that (given the symbols on the player's bingo card) yields the ultimate outcome, and (4) present the selected combination of symbols to the player via a display element being used by the player to play the bingo game. In some such embodiments, the initial outcome tables may be generated (e.g., selected) based on the player's bingo card.

In some examples, the disclosed framework may be used to port a class II game (e.g., bingo) to a class III game. Because of the greater RTP control provided by the disclosed framework, porting a class II game to a class III game using the disclosed framework may enable a class III game to mimic the feel (e.g., the RTP) of a class II game more accurately. In these examples, one or more of the systems may (1) determine an RTP of the class II game, (2) based on the determined RTP, set weights for ultimate outcomes of the class II game and/or the initial outcomes of the class II game, and (3) use the weights to generate the ultimate outcome table and initial outcome tables of the game to be used when the game is played as a class III game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

Each of the computer-mediated actions described herein may be performed by a module that operates within an endpoint device (e.g., a user device and/or a dedicated gaming device) and/or that operates within a backend server. In the examples in which an action involves presenting digital content to a user via an endpoint device and/or receiving user input and/or digital feedback from the user to the endpoint device, the module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint), and/or indirectly (e.g., in examples in which the module operates within a server and/or within a different application than the application performing the presenting). In examples in which a module performs an action indirectly, the module may perform the action in a variety of ways. For example, the module may perform the action by instructing the endpoint device and/or the other application to perform the action, by transmitting content to the endpoint device and/or the other application to be presented by the endpoint device and/or the other application, by providing the endpoint with an application that performs the action, by receiving an indication of user input to the endpoint device and/or the other application from the endpoint device and/or the other application, etc. In some examples, the module may perform an action operating in a combination of an endpoint device and a backend server.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A gaming system comprising:
a processor;
a memory storing instructions thereon, wherein the instructions, when executed by the processor, cause the processor to:
select a certain ultimate outcome from an ultimate outcome table comprising a plurality of ultimate outcomes, wherein:
each ultimate outcome within the ultimate outcome table corresponds to a different initial outcome table;
each initial outcome table comprises one or more symbol combinations; and
each symbol combination within an initial outcome table comprises a combination of symbols that yields the initial outcome table's corresponding ultimate outcome;
in response to selecting the certain ultimate outcome from the ultimate outcome table, select, from a certain initial outcome table corresponding to the certain ultimate outcome, a certain combination of symbols that yields the ultimate outcome; and
present, via a display element of a device, the certain combination of symbols selected from the certain initial outcome table.

2. The gaming system of claim 1, wherein at least one of:
the certain ultimate outcome is selected from the ultimate outcome table at random; or
the certain combination of symbols is selected from the certain initial outcome table at random.

3. The gaming system of claim 1, wherein the certain ultimate outcome comprises at least one of a prize outcome, a no-prize outcome, or a bonus outcome.

4. The gaming system of claim 3, wherein the bonus outcome comprises an option to spin a digital wheel.

5. The gaming system of claim 3, wherein the prize comprises a payout.

6. The gaming system of claim 1, wherein the instructions further cause the processor to, after presenting the certain combination of symbols, present the certain ultimate outcome via the display device.

7. The gaming system of claim 6, wherein presenting the certain ultimate outcome comprises awarding a prize corresponding to the certain ultimate outcome.

8. The gaming system of claim 1, wherein the certain initial outcome table is a weighted table and one or more symbol combinations within the certain initial outcome table has an associated weight.

9. The gaming system of claim 1, wherein the ultimate outcome table is a weighted table and one or more ultimate outcome within the ultimate outcome table has an associated weight.

10. The gaming system of claim 1, wherein presenting the certain combination of symbols via the display element comprises presenting a different symbol from the certain combination of symbols in each of a plurality of reels.

11. The gaming system of claim 1, wherein certain combination of symbols corresponds to symbols on a bingo card.

12. The gaming system of claim 1, wherein:
the selecting and presenting are performed as part of a class III game; and
the instructions further cause the processor to port the class III game from a class II game.

13. An electronic gaming device comprising:
a display element; and
a game controller having at least one physical processor and memory comprising computer-executable instructions, an ultimate outcome table, comprising a plurality of ultimate outcomes, and a plurality of initial outcome tables, wherein:
each ultimate outcome within the ultimate outcome table corresponds to a different initial outcome table within the plurality of initial outcome tables;
each initial outcome table comprises one or more symbol combinations;
each symbol combination within an initial outcome table comprises a combination of symbols that yields the initial outcome table's corresponding ultimate outcome; and
the computer-executable instructions, when executed by the physical processor, cause the physical processor to:
select a certain ultimate outcome from the ultimate outcome table;
in response to selecting the certain ultimate outcome from the ultimate outcome table, select from a certain initial outcome table corresponding to the certain ultimate outcome, a certain combination of symbols that yields the ultimate outcome; and
present, via the display element, the certain combination of symbols selected from the certain initial outcome table.

14. The electronic gaming device of claim 13, wherein at least one of:
the certain ultimate outcome is selected from the ultimate outcome table at random; or
the certain combination of symbols is selected from the certain initial outcome table at random.

15. The electronic gaming device of claim 13, wherein the certain ultimate outcome comprises at least one of a prize outcome, a no-prize outcome, or a bonus outcome.

16. The electronic gaming device of claim 15, wherein the bonus outcome comprises an option to spin a digital wheel.

17. The electronic gaming device of claim 15, wherein the prize comprises a payout.

18. The electronic gaming device of claim 13, wherein the certain initial outcome table is a weighted table and one or more symbol combinations within the certain initial outcome table has an associated weight.

19. The electronic gaming device of claim 13, wherein the ultimate outcome table is a weighted table and one or more ultimate outcome within the ultimate outcome table has an associated weight.

20. A computer-implemented method comprising:
selecting a certain ultimate outcome from an ultimate outcome table comprising a plurality of ultimate outcomes, wherein:
each ultimate outcome within the ultimate outcome table corresponds to a different initial outcome table;
each initial outcome table comprises one or more symbol combinations; and
each symbol combination within an initial outcome table comprises a combination of symbols that yields the initial outcome table's corresponding ultimate outcome;
in response to selecting the certain ultimate outcome from the ultimate outcome table, selecting, from a certain initial outcome table corresponding to the certain ultimate outcome, a certain combination of symbols that yields the ultimate outcome; and
presenting, via a display element of a device, the certain combination of symbols selected from the certain initial outcome table.
